(19) United States
(12) Patent Application Publication
(10) Pub. No.: US 2024/0281448 A1
(43) Pub. Date: Aug. 22, 2024

(54) System and Method for Assessing Romantic Partners

(71) Applicant: Alicia Rodriguez, Visalia, CA (US)

(72) Inventor: Alicia Rodriguez, Visalia, CA (US)

(21) Appl. No.: 18/346,466

(22) Filed: Jul. 3, 2023

Related U.S. Application Data
(60) Provisional application No. 63/446,476, filed on Feb. 17, 2023.

(51) Int. Cl. G06F 16/2457

(52) U.S. Cl. CPC G06F 16/24578; G06F 16/24575

(57) ABSTRACT

A system including a mobile application to assist users in assessing current and/or potential romantic partners/mates based on specific criteria. The application enables users to create a list of, for example, the top ten categories that are important to them in a relationship, and then further specify, for example, the ten subcategories for each category. The system can identify potential partners and the application assesses each potential (or current) partner based on feedback (i.e., prevalence) and behaviors. The system provides users with notifications of deal-breakers and desirable traits. The system helps users avoid investing time and effort in partners who do not meet their expectations (i.e., do not possess the desired traits) and ultimately assists the users in making informed and objective decisions in relationships.

### CROSS-REFERENCE TO RELATED APPLICATION

The present application claims priority to, and the benefit of, U.S. Provisional Application No. 63/446,476, which was filed on Feb. 17, 2023, and is incorporated herein by reference in its entirety.

### FIELD OF THE INVENTION

The present invention generally relates to the field of matching systems. More specifically, the present invention relates to a novel system and computer-implemented method for assessing and rating potential romantic partners. The system uses a computer implemented application enabling users to select categories and subcategories for identifying potential romantic partners and assessing them to identify compatible partners. The system helps in assessing partners objectively and not emotionally. Accordingly, the present disclosure makes specific reference thereto. Nonetheless, it is to be appreciated that aspects of the present invention are also equally applicable to other like applications, devices, and methods of manufacture.

### BACKGROUND

By way of background, relationships are an important aspect of human life, as they provide humans with emotional support, companionship, and a sense of belonging. Finding the right partner is crucial in a relationship because it can lead to a fulfilling and long-lasting relationship. A healthy and supportive relationship can provide emotional stability, happiness, and personal growth. However, many people end up investing their time and emotions in a person who does not meet their standards, leading to frustration and failed relationships. Divorce rates have been on the rise due to the failure of couples to recognize and address their differences early on in the relationship. A relationship with the wrong partner can lead to emotional distress, stress, and negative impact on mental health.

Currently, people often approach relationships and finding partners emotionally rather than intellectually. People commonly allow their feelings and instincts to guide them when searching for an ideal mate, rather than thinking critically about what they really want in a partner. Emotions cloud judgment and cause people to make decisions based on short-term feelings rather than long-term compatibility. As a result, people overlook important traits or characteristics that are essential for a healthy, fulfilling relationship. This can lead to investing time and effort in partners who are not a good match, ultimately resulting in disappointment, frustration, and possibly heartbreak.

Approaching relationships intellectually enables people to be more thoughtful and intentional in our search for an ideal partner. This can lead to more successful and fulfilling relationships, where both partners are compatible and happy together. However, currently there is no system available for people to approach finding their romantic partners intellectually. People desire a system that helps people make informed decisions in relationships.

Therefore, there exists a long felt need in the art for a system that helps people make informed decisions in relationships. There is also a long felt need in the art for a tool that enables individuals to assess potential partners based on specific criteria. Additionally, there is a long felt need in the art for a system that reduces the role of emotions in finding romantic partners. Moreover, there is a long felt need in the art for a system that helps people in assessing the potential in romantic partners. Further, there is a long felt need in the art for a system that helps users to identify their own preferences and expectations, enabling them to identify desired traits, thus making more informed decisions about their relationships. Finally, there is a long felt need in the art for a system that gives users a solid representation of their current, or potential, partner's characteristics, enabling users to compare what or who they are dating versus what or who they are truly looking for.

The subject matter disclosed and claimed herein, in one embodiment thereof, comprises a computer implemented method for using a mobile application to select and rate current and potential (i.e., prospective) romantic partners. The method includes the steps of selecting a plurality (i.e., ten) of categories from a list of many (i.e., thirteen) categories, selecting or manually entering subcategories for each category, wherein each subcategory relates to a desirable trait. Additionally the user establishes one or more threshold questions that can act as red flags for rejecting the potential partner, answering and grading criterion to evaluate potential partners, evaluates, assesses, and rates the partners wherein the rating is compared to the users ideal answers.

In this manner, the partners rating system and associated method of the present invention accomplishes all of the forgoing objectives and provide users with an application that enables them to avoid investing their time in relationships that are unlikely to meet their expectations or thrive. The system and method allow individuals to make more informed decisions in relationships and avoid the frustration and disappointment that often come with failed relationships.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a computer implemented method for using a mobile application to select and rate potential romantic partners. The method includes the steps of selecting, for example, ten categories from a list of, for example, thirteen categories, then selecting or manually entering subcategories for each category, wherein each subcategory relates to a trait of a user. Putting in place one or more threshold questions wherein, each threshold question acts as a red flag for rejecting the potential partner, establishing criterion to evaluate potential partners, the application assesses current and/or potential (i.e., prospective) partners and rates partners wherein the rating is compared to a rating threshold to determine whether or not the user should pursue (or continue) that relationship.

In another aspect of the present invention, a mate rating system is disclosed. The mate rating system includes a mate rating application installed in a user device, which communicates with a server via a communication channel. The application provides various functionality on the client device and enables the user to receive, view, and interact with digital content and user interfaces provided by the system. The server maintains profiles of registered users in a plurality of databases, including personal details and preferences for deciding on current and/or potential romantic partners and the server is further configured to provide different weightages (i.e., weights) to categories for assessing romantic partners for users.

In yet another embodiment, a system for evaluating potential romantic partners, called “Rate Your Mate” is disclosed. The system is available in the form of a mobile application that utilizes different criteria to assess the suitability of a romantic partner. The application includes “Threshold” questions that alert the user to deal-breaking behaviors, and “Criterion” that indicate a potential partner's positive attributes. The feedback provided by the application is based on the user's previously submitted preferences, and each “Criterion” is assigned a point value to identify desirable traits. The application displays a list of, for example, thirteen categories from which, for example, ten subcategories are selected by a user. For each selected category, the user is prompted to list ten subcategories containing specific traits that they desire in a potential partner. The user may use examples provided by the application or create their own category to further identify desirable traits.

In yet another embodiment, thirteen categories include Physical Appearance, Sexual preferences, Personality, Spiritual, Communication, Financial, Emotional, Personal Growth, Education, Interest/Hobbies, Lifestyle, Parenting, and Miscellaneous.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an exemplary system for assessing romantic partners for users in accordance with the disclosed architecture;

FIG. 2 illustrates a flow diagram depicting a process of assessing romantic partners based on different criteria using the system of FIG. 1 in accordance with the disclosed architecture;

FIG. 3 illustrates a flow diagram depicting a process of using Threshold questions for assessing the romantic partners using the system of FIG. 1 in accordance with the disclosed architecture;

FIG. 4 illustrates a flow chart depicting use of “Criterion” for assessing the romantic partners using the system of FIG. 1 in accordance with the disclosed architecture;

FIG. 5 illustrates an exemplary user interface displaying different categories available in the application for selection by a user for identifying and rating potential romantic partners in accordance with the disclosed architecture;

FIG. 6 illustrates an exemplary user interface displaying different subcategories for an exemplary category in the application in accordance with the disclosed architecture;

FIG. 7 illustrates an exemplary user interface showing the Threshold question used as a red flag and the Criterion used for selecting a potential romantic partner in accordance with the disclosed architecture;

FIG. 8 illustrates a flow chart depicting another process of working of the mate rating application of the present invention for assessing potential romantic partners in accordance with the disclosed architecture; and

FIG. 9 illustrates another flow chart depicting yet another process of working of the mate rating application of the present invention for grading and/or rating current and/or potential romantic partners in accordance with the disclosed architecture

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a system that helps people make informed decisions in relationships. There is also a long felt need in the art for a tool that enables individuals to assess current and/or potential (i.e., prospective) partners based on specific criteria. Additionally, there is a long felt need in the art for a system that reduces the role of emotions in finding romantic partners. Moreover, there is a long felt need in the art for a system that helps people in assessing their romantic partners. Further, there is a long felt need in the art for a system that helps users to identify their own preferences and expectations, enabling them to make more informed decisions about the potential of the relationship. Finally, there is a long felt need in the art for a system that gives users a solid representation of their partner's characteristics, enabling users to compare what or who they are dating versus what or who they are truly looking for.

The present invention, in one exemplary embodiment, is a system for evaluating potential romantic partners, called “Rate Your Mate”. The system is available in the form of a mobile application that utilizes different criteria to assess the suitability of a romantic partner. The application includes “Threshold” questions, as standards or ‘deal breakers’, that alert the user to deal-breaking behaviors, and “Criterion” that indicate the user's preferences in a partner. The feedback provided by the application is based on the user's submitted preferences when setting up profile, and each “Criterion” is assigned a point value to compare desirable traits. The application displays a list of, for example, thirteen categories from which, for example, the user selects the ten most important categories, then ten subcategories are selected by a user representing user preferences. For each selected category, the user is prompted to list ten subcategories containing specific traits that they desire in a potential partner. The user may use examples provided by the application or create their own category to further identify desirable traits.

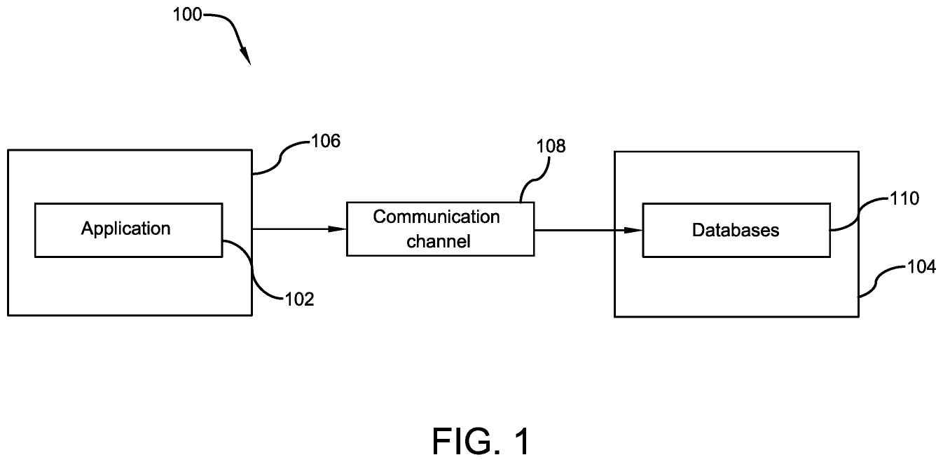

Referring initially to figures, FIG. 1 illustrates an exemplary system for assessing romantic partners for users in accordance with the disclosed architecture. In the mate rating system 100, a mate rating application 102 is installed in a user device 106 such as a smartphone for accessing a server 104 via a communication channel 108. The application 102 is a computer implemented software application and is configured to provide and control various functionality on the client device 106 to enable a respective user of the client device 106 to receive, view, and interact with different digital content and user interfaces provided by the romantic partners rating system 100. In one or more alternative embodiments of the present invention, the mate rating application 102 refers to a web browser used to access the server 104.

The application 102 and the server 104 communicates over the communication channel 108 which may include one or multiple networks and may use one or more communication platforms or technologies suitable for transmitting data. In one or more embodiments, the communication channel 108 includes the Internet or World Wide Web. In addition, or as an alternative, the communication channel 108 can include various other types of networks that use various communication technologies and protocols. The server 104 is configured to maintain profiles of different users registered in the system 100 in a plurality of databases 110. The profile of the users may include personal details such as name, hobbies, location, age, gender and more and also includes preferences for assessing current and/or potential romantic partners.

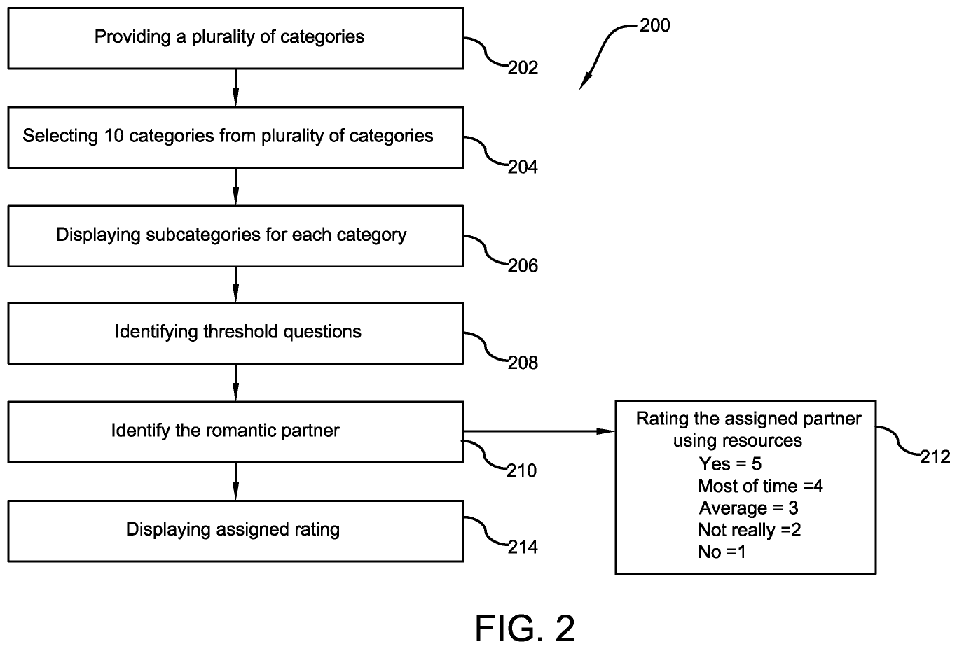

FIG. 2 illustrates a flow diagram 200 depicting a process of assessing romantic partners based on different criteria using the system of FIG. 1 in accordance with the disclosed architecture. The present invention is used for grading current and/or potential romantic partners by offering a systematic approach based on a selected criterion. More specifically, at step 202, the server 104 provides a plurality of categories available in the application 102. The plurality of categories is used for rating a partner and helps users in deciding to continue and/or pursue relationships. The plurality of categories can include physical appearance, sexual preference, personality, spiritual, communication, financial, emotional, personal growth, education, interest/hobbies, lifestyle, parenting, and miscellaneous. Then, in step 204, a subset of, for example, ten categories preferred by a user are selected using the application 102. The ten categories are manually selected by the user based on the most important categories as per the preferences thereof.

Thereafter, in step 206, for each selected category of, for example, the ten categories, a plurality of subcategories is displayed. Each subcategory is specific to a trait and can be auto-populated by server 104 or can alternatively be manually input or added by a user as per the personal preferences. These subcategories and traits help to provide more specific information about what the user is looking for in a partner. Then, in step 208, the user can identify three threshold questions that are deal breakers in order to filter out individuals who don't meet basic standards for the user. A corresponding grading is also provided for the partner based on the selected categories and subcategories in step 210.

In one exemplary case, a partner is inputted by the user in the system 100, then the partner is rated by the system 100 threshold questions, in step 210 and using the selected categories and subcategories (and answers) in step 212. Finally, in step 214, the application 102 displays the rating for enabling the user to make an informed decision about the partner based on the score.

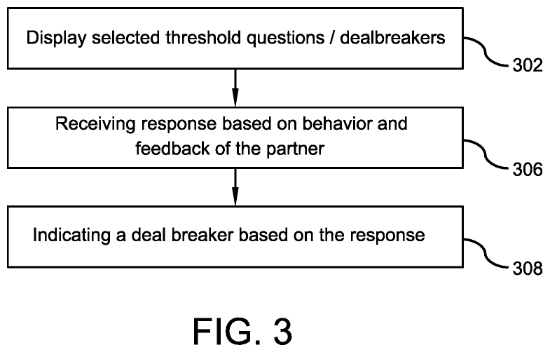

FIG. 3 illustrates a flow diagram depicting a process in step 210 of use of Threshold questions for assessing the romantic partners using the system of FIG. 1 in accordance with the disclosed architecture. The application 102 upon establishing standards, displays the selected threshold questions (Step 302). The selection is performed by a user using an interface of the application 102. The user establishes their unique standards (i.e., threshold questions) such as, drug free, non-violent, monogamous, and more. If the potential partner does not pass the first set of standards (i.e., affirmative to initial threshold assessments or deal breakers), then the potential partner does not go any further.

Based on behavior, profile, and feedback of the partners in the system 100, a response is received by the system 100 and is displayed to the user (Step 306). The response to the threshold questions can be reviewed by the user or can be automatically reviewed by the system 100 based on profile of the user. The “Threshold” questions help users establish standards so they can focus on the other aspects of categories in selection and/or rating of their romantic partners and preferences knowing there are not deal breakers present at this point.

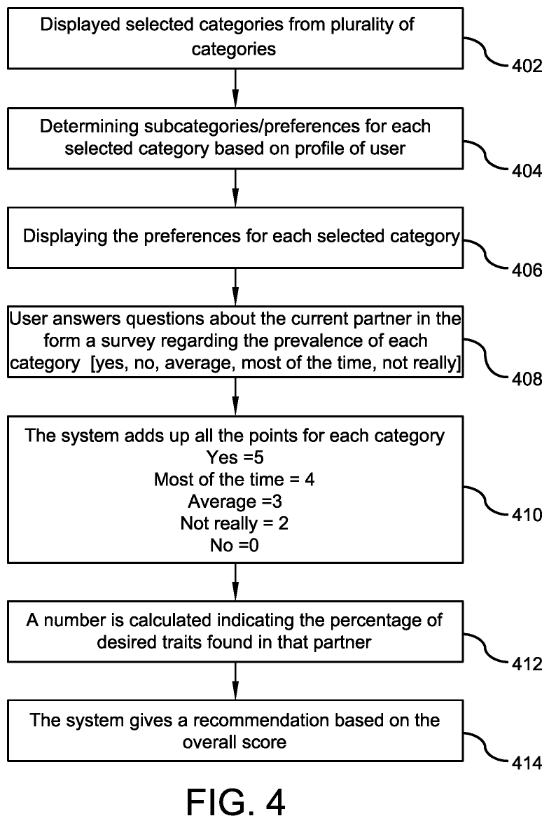

FIG. 4 illustrates a flow chart depicting use of “Criteria” for assessing the romantic partners using the system of FIG. 1 in accordance with the disclosed architecture. The romantic partners application 102 includes “Criteria” that is sorted by the use based on what areas the user feels are important in relationships. The Criteria can include subcategories (i.e., 10 selected subcategories) which are the user's preferences or desirable traits under each category. Each category can have a maximum value of, for example, 50 and each subcategory can have a maximum value of, for example, 5 based on point values assigned to each respective category and subcategory. Initially, the application 102 upon selection of categories by a user, displays the selected categories as per preferences of the user (Step 402). Then, based on the preferences of a user, subcategories are populated for each selected category (Step 404). The subcategory is also graded or rated using the point values provided to each category as described later in the disclosure.

The determined subcategories are displayed (Step 406) by the application 102 for the user and helps the user compare the current (or potential) partner traits against the user's predisposed preferences (i.e., desirable traits) of a partner. For each preference or subcategory, the user will answer either ‘yes’, ‘most of the time’, ‘average’, ‘not really’, and ‘no’. If the current partner displays any of the preferred traits (i.e., has a prevalence for), then every answer is assigned a point value as described in Step 408. The system accumulates all of the points (step 410) that have been assessed for each subcategory. The system generates a number (step 412) or a percentage (%) based on the total points accumulated divided by the total number of points possible (i.e., # of selected subcategories×5). The system can provide a recommendation to the user based on the overall score and the overall prevalence of desired traits of another (step 414).

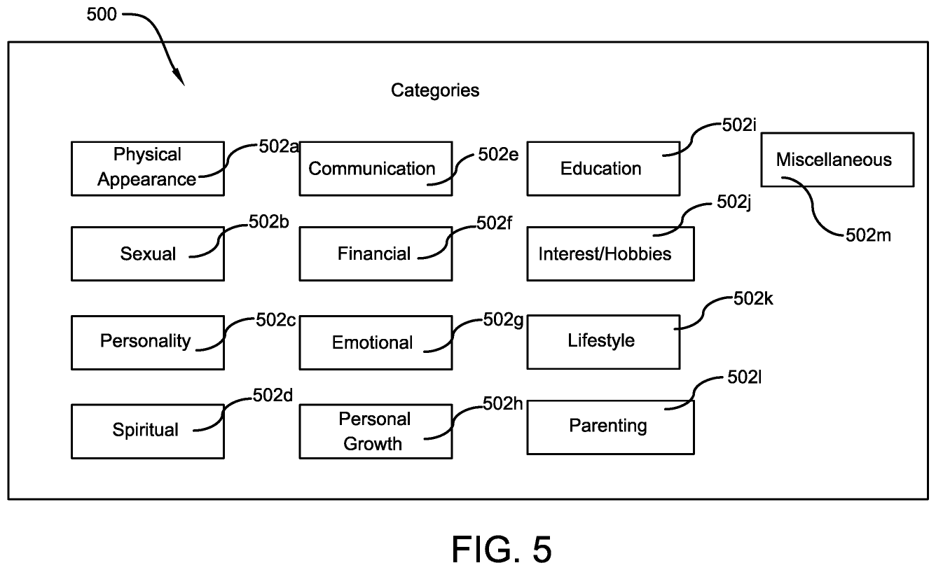

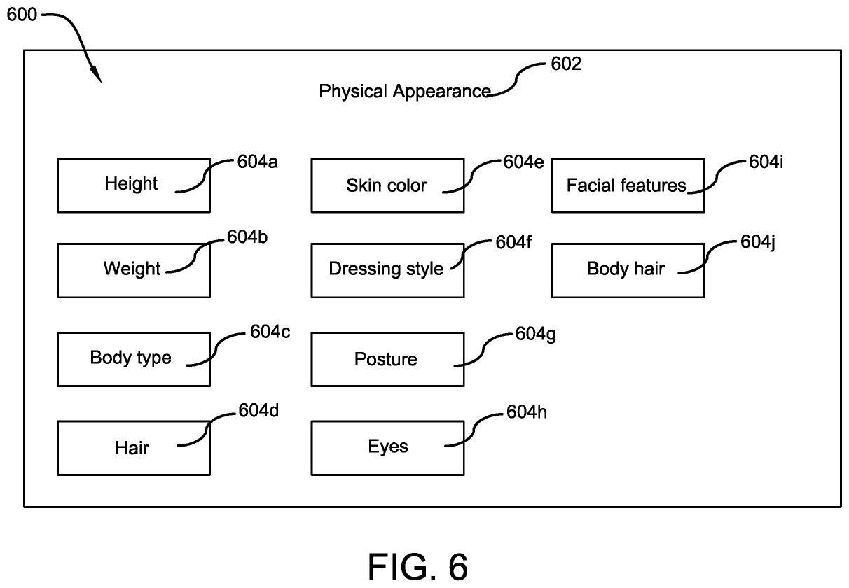

FIG. 5 illustrates an exemplary user interface 500 displaying different categories available in the application 102 for selection by a user for identifying desirable traits and rating potential romantic partners in accordance with the disclosed architecture. The application 102 provides a plurality of, for example, thirteen categories 502a-m enabling the user to make up their own category to include and subcategories that are not already listed or don't fit elsewhere. The interface 500 also enables a user to select a set of categories from the thirteen categories 502a-m. The miscellaneous category is a ‘free for all’ category that the user can include a desirable trait that does not fit elsewhere or the user can repeat another trait if it is important to the user. Each category is selectable and displays the subcategories corresponding to the selected category as illustrated in FIG. 6. As an example, the user inputs the data for each category.

The thirteen categories 502a-m are preconfigured in the system 100 and can be customized as per requirements of users. Further, categories can also be manually or automatically customized depending on preferences of users.

FIG. 6 illustrates an exemplary user interface 600 displaying different subcategories for an exemplary category 602 in the application 102 in accordance with the disclosed architecture. As illustrated, the interface 600 displays a plurality of subcategories 604a-j for the selected category 602 “Physical Appearance” (same as of the category 502a in FIG. 5). The subcategories 604a-j can be predetermined and preconfigured and can also be customized based on the profile and preferences of the user. Each subcategory is used for grading or rating current and/or potential romantic partners with a score or point system to automatically rate a partner. Each category is worth a maximum of 50 points which are an accumulation of 5 points maximum for each subcategory. At the end, the system will add all partners' points and divide by the total possible points to calculate a percentage. Each category is graded or rated in order to contribute to the overall grade in order to assess the complete personality of the current and/or potential partner and helps in assessing the overall score, and thereby enabling the user to decide if the score is high enough to pursue or continue the relationship.

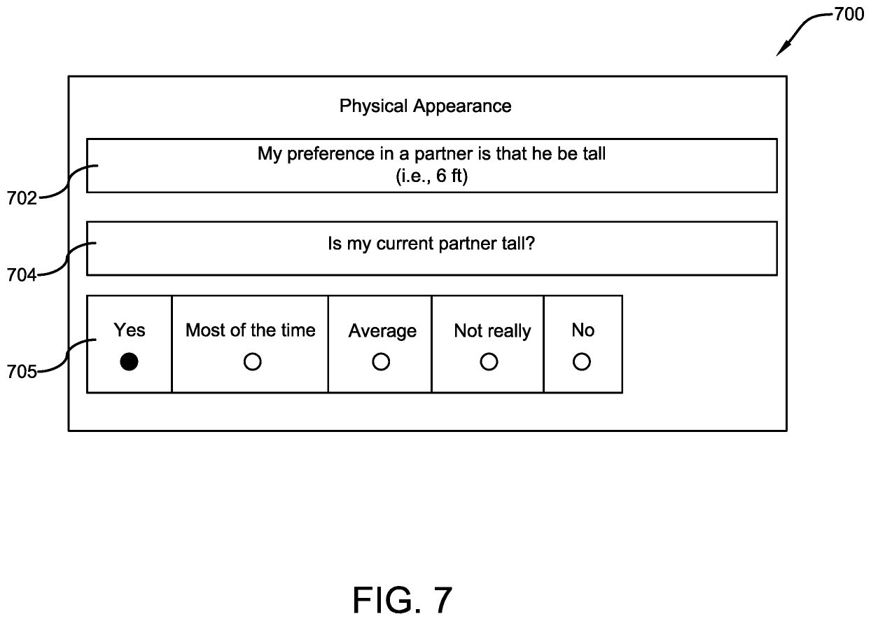

FIG. 7 illustrates an exemplary user interface showing the grading of partners by answering 1 out of 5 prevalence's for each subcategory of each category in accordance with the disclosed architecture (step 705). As described earlier in FIGS. 4 and 7, the application 102 provides at least 5 ways the user can answer questions about their current or prospective partner as it relates for each category for an effective and correct assessment of a romantic partner. Accordingly, as illustrated, for the category “Physical Appearance” 602, a predisposed preference, for example, “I prefer a tall partner” 702 can be displayed and can act as a desirable trait of a partner. The weightage or prevalence of the desirable trait is worth between 0 and 5 points based on the response in step 705. The subcategories 702 help to provide more specific information about what the user is looking for.

The comparison 704 “Does the current and/or potential partner display qualities that the user finds attractive?” provides feedback on the percentage the current and/or potential partner is to what the user wants if the current and/or potential partner scored as a percentage of a maximum score of 50 points. Thus, the closer the graded or rated partner scores to 50 the higher the percentage match and the higher the current and/or potential partner is to a match for the user. It should be noted that the application 102 can display any of the 5 choices to answer on each subcategory as per the selected category and choices of the user.

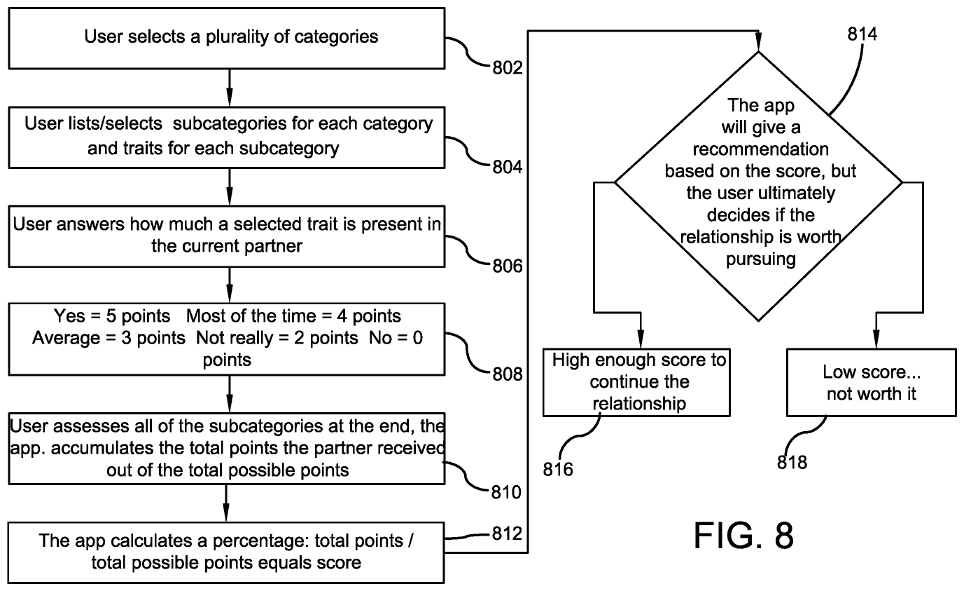

FIG. 8 illustrates a flow chart depicting another process of working of the mate rating application 102 of the present invention for grading and/or rating current and/or potential romantic partners in accordance with the disclosed architecture. Initially, a user selects, for example, 10 categories from a displayed list of 13 categories (Step 802). Then, the user either manually picks or selects from an existing list of subcategories for each selected category (Step 804). Each subcategory represents a trait for defining an aspect of the category. Thereafter, the user answers how frequent the desired trait is found within their current (and/or prospective) partner (Step 806). Each subcategory is scored based on the prevalence of the subcategory in the current or prospective partner (step 808). The user assesses all subcategories and accumulates a total point score of a current or potential partner (step 810).

Then, the application 102 (step 812) calculates the partner's total points and divides by the total possible points (i.e., the maximum point total from the system). Thereafter, the application 102 recommends how to proceed based on a score value system for rating the partners (Step 814). A high score results in a decision to continue a relationship (step 816) and a low score results in a discontinuation of a relationship (step 818). The rating threshold can be automatically determined by the server 104 based on preferences of the user and/or user standards. In case the rating is less than the rating threshold, then the user is not enabled to continue rating that mate/partner because the mate/partner is disqualified.

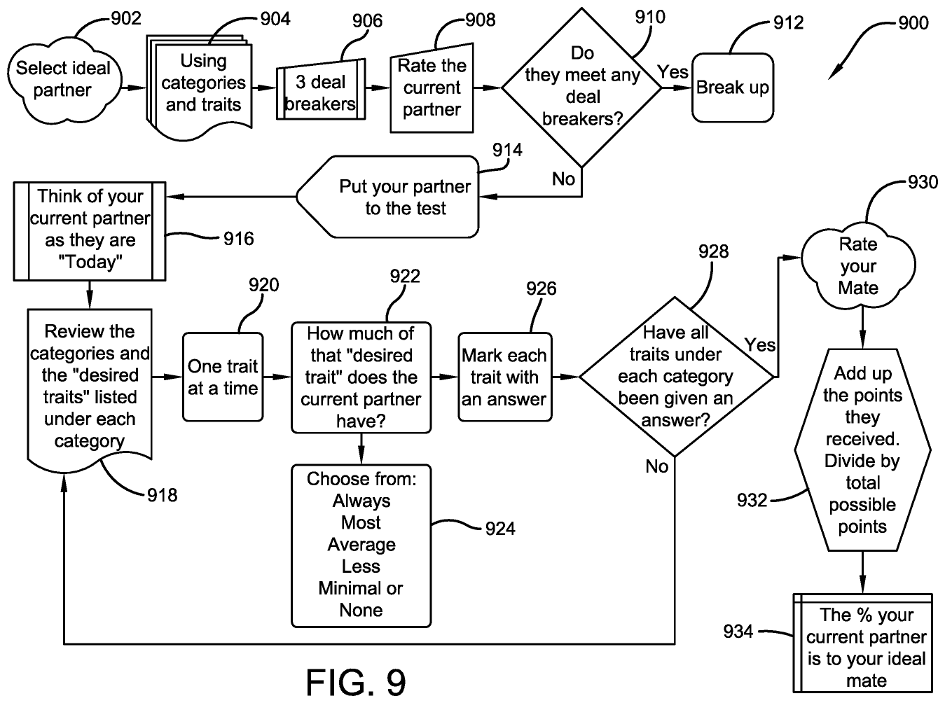

FIG. 9 illustrates another flow chart 900 depicting another process of working of the mate rating application 102 of the present invention for grading and/or rating current and/or potential romantic partners in accordance with the disclosed architecture. Initially, a user creates an ideal partner 902 using categories and traits 904. Deal breakers can be identified 906. The current partner is selected for rating 908 and the deal breakers are applied 910. If a deal breaker is identified, then break up is suggested 912. If deal breaker is not identified, then the selected partner is graded or rated in the system 914. The selected partner can be rated in the present tense 916. The categories are reviewed along with the desired traits listed under each category 918. Each trait is then assessed 920. The prevalence of each desired trait is assessed for the selected partner 922. The prevalence choices can include five assessments along with associated point scores 924. Each trait is marked with an answer 926. Once all traits have been given an answer 928, a rating is determined 930. All of the points are accumulated and divided by a total of possible points 932 to determine a compatibility percentage. The compatibility percentage can be compared to the ideal mate 934.

Table 1 below displays one exemplary arrangement of the customized weightages or weights provided to the categories used for assessing partners by the user in accordance with one embodiment of the present invention. The weightages can be used in the scoring system to calculate the total score for a current and/or potential partner. Although not displayed in the tables below, it is to be appreciated that each category can have a weightage (i.e., weight factor) in the range between 0 and 5 points. In one exemplary arrangement, all subcategories are weighted the same importance.

The grading system can include the following scoring arrangement. The user compares the current (or potential) partner's traits against the user's predisposed preferences (i.e., desirable traits) of a partner. The grading system can include a score of 5 if the trait is clearly present (i.e., answer ‘yes’); a score of 4 if the trait is present more than it is not (i.e., answer ‘most of the time’); a score of 3 if the trait is present half of the time (i.e., answer ‘average’); a score of 2 if the trait has been seen before (i.e., answer ‘not really’); and, a score of 0 if the trait is clearly not present (i.e., answer ‘no’). Each subcategory can include a point grade as described above. All the scores are summed to receive an actual total point score. The actual total point score is divided by the total possible points (the # of subcategories scored×5) to calculate a percentage of compatibility (i.e., a compatibility index). The higher the percentage, the higher the compatibility. Depending on the compatibility index, the use can decide to continue or pursue a relationship with the graded individual. It is to be appreciated that the grading and rating system as described has the capacity to match up individuals based on their respective inputs and the values placed on selected categories and subcategories. For example, a first user can do a self-assessment of, or develop a profile of preferred, categories and subcategories and give themselves a score for each chosen subcategory. A second user can do likewise. The system can then match those individuals that score similarly in the selected subcategories and/or that match favorably the qualities preferred in a partner (i.e., partner possesses the desired qualities). Therefore, the ‘rate your mate’ system is both a grading tool and a matching tool.

TABLE 1

| Categories | Weightage |
|---|---|
| Physical Appearance: | 5% |
| Sexual: | 5% |
| Personality: | 5% |
| Spiritual: | 5% |
| Communication: | 5% |
| Financial | 5% |
| Emotional | 5% |
| Personal Growth | 5% |
| Education | 5% |
| Interest/Hobbies | 5% |
| Lifestyle | 5% |
| Parenting | 5% |
| Miscellaneous | 5% |

Table 2 below displays the subcategories for the Physical Appearance category.

TABLE 2
Subcategories

Height
Hygiene
Clean cut
Style
Facial hair
Handsome
Fitness
Wardrobe
Confidence level
Dental hygiene/condition

Table 3 below displays the subcategories for the Sexual category.

TABLE 3
Subcategories

Sexual orientation
Sex educations
Sexual compatibility
Turn-ons
Turn-offs
Birth control preference
STD status
Body count
Experimentation
Communication about sex

Table 4 below displays the subcategories for the Personality category.

TABLE 4
Subcategories

Kindness
Sense of humor
Intelligence
Empathy
Honesty
Open-mindedness
Emotional stability
Confidence
Assertiveness
Compassion

Table 5 below displays the subcategories for the Spiritual category.

TABLE 5
Subcategories

Religious beliefs
Spiritual practices
Belief in afterlife
Belief in higher power
Meditation practice
Yoga practice
Energy healing
Attitude towards death
Respect for others' beliefs
Alignment with your spiritual beliefs

Table 6 below displays the subcategories for the Communication category.

TABLE 6
Subcategories

Communication style
Listening type
Conflict resolution
Non-verbal communication
Assertiveness
Language
Timing of communication
Use of technology
Depth of conversation
Supportive language

Table 7 below displays the subcategories for the Financial category.

TABLE 7
Subcategories

Income
Spending habits
Saving habits
Debt/Loan
Financial goals
Investment strategy
Attitude towards money
Money management skills
Generosity
Work ethic

Table 8 below displays the subcategories for the Emotional category.

TABLE 8
Subcategories

Emotional intelligence
Self-awareness
Self-regulation
Empathy
Trust
Vulnerability
Resilience
Emotional expression
Emotional balance
Vulnerability

Table 9 below displays the subcategories for the Personal growth category.

TABLE 9
Subcategories

Learning
Self-improvement
Self-awareness
Openness to feedback
Mindfulness
Personal challenges
Comfort zone
Self-reflection
Self-acceptance
Motivation

Table 10 below displays the subcategories for the Education category.

TABLE 10
Subcategories

Level of education
Area of study
Career path
Intellectual curiosity
Critical thinking
Analysis
Creativity
Genre
Teaching style
Continuing education

Table 11 below displays the subcategories for the Interest/Hobby category.

TABLE 11
Subcategories

Sports
Fitness
Art
Music
Literature
Travel
Cooking
Dancing
Gaming
Nature

Table 12 below displays the subcategories for the Lifestyle category.

TABLE 12
Subcategories

Health and wellness
Diet and nutrition
Fitness and exercise
Travel and adventure
Social life and friends
Entertainment and leisure
Career and work-life balance
Home and living environment
Fashion and style
Values and beliefs

Table 13 below displays the subcategories for the Parenting category.

TABLE 13
Subcategories

Child-rearing philosophy
Discipline style
Education and learning
Family bonding and quality time
Safety and protection
Health and wellness
Emotional support and communication
Community learning
Personal interests and hobbies
Outdoor learning

Table 14 below displays the subcategories for the Miscellaneous category.

TABLE 14
Subcategories

Humor
Creativity and artistic expression
Adventure
Communication style
Attitude towards technology
Political orientation
Religious beliefs and practices
Family orientation
Attitude towards pets and animals
Financial goals and values

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “mate rating system”, “romantic partners assessing system”, “romantic partners rating system”, and “system” are interchangeable and refer to the romantic partners assessing and rating system 100 of the present invention.

In this regard, FIGS. 1-8 are block diagrams and flowchart illustrations of methods, systems, and program products according to the invention. It will be understood that each block or step of the block diagram, flowchart and control flow illustrations, and combinations of blocks in the block diagram, flowchart, and control flow illustrations, can be implemented by computer program instructions. These computer program instructions may be loaded onto a computer or other programmable apparatus to produce a machine, such that the instructions that execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Notwithstanding the forgoing, the romantic partners assessing and rating system 100 of the present invention can be of any suitable configuration as is known in the art without affecting the overall concept of the invention, provided that it accomplishes the above stated objectives. One of ordinary skill in the art will appreciate that the romantic partners assessing and rating system 100 as shown in the FIGS. are for illustrative purposes only, and that many other configuration and design of the romantic partners assessing and rating system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mate rating application comprising:
an electronic user device having a mate rating application installed thereon;
a communication channel for accessing a server with said electronic user device;
wherein said mate rating application is a computer implemented software application including functionality controls of a client device for enabling a user of said client device to receive, view, and interact with digital content of said mate rating application;
wherein said mate rating application including a web browser for accessing said server;
wherein said mate rating application and said server communicating over said communication channel;
wherein said server having a profile of users including personal details selected from a group consisting of a name, a hobby, a location, an age, and a gender;
wherein said server having a plurality of categories for assessing partners based on criteria selected from a group consisting of a physical appearance category, a sexual category, a personality category, a spiritual category, a communication category, a financial category, an emotional category, a personal growth category, an education category, an interest/hobby category, a lifestyle category, a parenting category, and a miscellaneous category;
wherein each of said plurality of categories having a plurality of subcategories for said assessing partners; and
a partner grading is compiled for said assessing partners based on a rating of selected said plurality of categories and based on a rating of selected said plurality of subcategories.

2. The mate rating application of claim 1, wherein said plurality of categories having a plurality of threshold questions for said assessing partners.

3. The mate rating application of claim 2, wherein at least one of said plurality of threshold questions asks about drug use of another user for said assessing partners.

4. The mate rating application of claim 1, wherein said partner grading is compiled for said assessing partners based on a rating of at least ten selected said plurality of categories.

5. The mate rating application of claim 1, wherein each of said plurality of categories includes a weight factor.

6. The mate rating application of claim 1, wherein said subcategories for said sexual category is selected from a group consisting of a sexual orientation, a sex education, a sexual compatibility, a turn-on, a turn-off, a birth control preference, an STD status, a body count, an experimentation, and a communication about sex.

7. The mate rating application of claim 6, wherein said subcategories for said personality category is selected from a group consisting of a kindness, a sense of humor, an intelligence, an empathy, an honesty, an open-mindedness, an emotional stability, a confidence, an assertiveness, and a compassion.

8. The mate rating application of claim 7, wherein said subcategories for said spiritual category is selected from a group consisting of a religious belief, a spiritual practice, a belief in afterlife, a belief in higher power, a meditation practice, a yoga practice, an energy healing, an attitude towards death, a respect for others' beliefs, and an alignment with a user's spiritual beliefs.

9. The mate rating application of claim 8, wherein said subcategories for said communication category is selected from a group consisting of a communication style, a listening type, a conflict resolution, a non-verbal communication, an assertiveness, a language, a timing of communication, a use of technology, a depth of conversation, and a supportive language.

10. The mate rating application of claim 9, wherein said subcategories for said financial category is selected from a group consisting of an income, a spending habit, a saving habit, a debt/loan, a financial goal, an investment strategy, an attitude towards money, a money management skill, a generosity, and a work ethic.

11. The mate rating application of claim 10, wherein said subcategories for said emotional category is selected from a group consisting of an emotional intelligence, a self-awareness, a self-regulation, an empathy, a trust, a vulnerability, a resilience, an emotional expression, and an emotional balance.

12. The mate rating application of claim 11, wherein said subcategories for said personal growth category is selected from a group consisting of a learning, a self-improvement, a self-awareness, an openness to feedback, a mindfulness, a personal challenge, a comfort zone, a self-reflection, a self-acceptance, and a motivation.

13. The mate rating application of claim 12, wherein said subcategories for said education category is selected from a group consisting of a level of education, an area of study, a career path, an intellectual curiosity, a critical thinking, an analysis, a creativity, a genre, a teaching style, and a continuing education.

14. The mate rating application of claim 13, wherein said subcategories for said interest/hobby category is selected from a group consisting of a sport, a fitness, an art, a music, a literature, a travel, a cooking, a dance, a game, and a nature.

15. The mate rating application of claim 14, wherein said subcategories for said lifestyle category is selected from a group consisting of a health and wellness, a diet and nutrition, a fitness and exercise, a travel and adventure, a social life and friends, an entertainment and leisure, a career and work-life balance, a home and living environment, a fashion and style, and a value and belief.

16. The mate rating application of claim 15, wherein said subcategories for said parenting category is selected from a group consisting of a child-rearing philosophy, a discipline style, an education and learning, a family bonding and quality time, a safety and protection, a health and wellness, an emotional support and communication, a community learning, a personal interest and hobby, and an outdoor learning.

17. The mate rating application of claim 16, wherein said subcategories for said miscellaneous category is selected from a group consisting of a humor, a creativity and artistic expression, an adventure, a communication style, an attitude towards technology, a political orientation, a religious belief and practice, a family orientation, an attitude towards pets and animals, and a financial goal and value.

18. A mate rating application comprising:
an electronic user device having a mate rating application installed thereon;
a communication channel for accessing a server with said electronic user device;
wherein said mate rating application is a computer implemented software application including functionality controls of a client device for enabling a user of said client device to receive, view, and interact with digital content of said mate rating application;
wherein said mate rating application including a web browser for accessing said server;
wherein said mate rating application and said server communicating over said communication channel;
wherein said server having a profile of users including personal details selected from a group consisting of a name, a hobby, a location, an age, and a gender;
wherein said server having a plurality of categories for assessing partners based on criteria selected from a group consisting of a physical appearance category, a sexual category, a personality category, a spiritual category, a communication category, a financial category, an emotional category, a personal growth category, an education category, an interest/hobby category, a lifestyle category, a parenting category, and a miscellaneous category;
wherein each of said plurality of categories having a plurality of subcategories for said assessing partners;
a partner grading is compiled for said assessing partners based on a rating of selected said plurality of categories and based on a rating of selected said plurality of subcategories; and
further wherein said selected said plurality of categories includes a selection of at least a majority of said plurality of categories.

19. The mate rating application of claim 18, wherein said partner grading is compiled for said assessing partners based on a rating of at least ten selected said plurality of categories.

20. A method of rating a mate, the method comprising the steps of:
providing an electronic user device having a mate rating application and a communication channel installed thereon;
accessing a server with said electronic user device and said communication channel;
wherein said mate rating application is a computer implemented software application including functionality controls of a client device for enabling a user of said client device to receive, view, and interact with digital content of said mate rating application;
wherein said mate rating application including a web browser for accessing said server;
wherein said mate rating application and said server communicating over said communication channel;
wherein said server having a profile of users including personal details selected from a group consisting of a name, a hobby, a location, an age, and a gender;
wherein said server having a plurality of categories;
assessing partners based on criteria selected from a group consisting of a physical appearance category, a sexual category, a personality category, a spiritual category, a communication category, a financial category, an emotional category, a personal growth category, an education category, an interest/hobby category, a lifestyle category, a parenting category, and a miscellaneous category;
wherein each of said plurality of categories having a plurality of subcategories for said assessing partners;
grading a partner based on a compilation and rating of selected said plurality of categories and based on a rating of selected said plurality of subcategories;
wherein said rating is based on a prevalence of each selected said plurality of subcategories in said assessing partners; and
further wherein said prevalence is selected from a group consisting of ‘yes’, ‘most of the time’, ‘average’, ‘not really’, and ‘no’.
